(19) United States
(12) Patent Application Publication
(10) Pub. No.: US 2015/0039459 A1
(43) Pub. Date: Feb. 5, 2015

(54) DETERMINING A PRICE ASSOCIATED WITH A WINNING BID

(71) Applicant: Google Inc., Mountain View, CA (US)

(72) Inventor: Patrick Hummel, Cupertino, CA (US)

(73) Assignee: Google Inc., Mountain View, CA (US)

(21) Appl. No.: 13/958,921

(22) Filed: Aug. 5, 2013

(51) Int. Cl. G06Q 30/08

(52) U.S. Cl. CPC G06Q 30/08
USPC 705/26.3

(57) ABSTRACT

Methods, systems, and apparatus include computer programs encoded on a computer-readable storage medium, including a method for determining bid prices for content items. A winner associated with an auction is identified for delivery of a content item, including identifying a first bid associated with the winner and an associated first expected clickthrough rate. A next finisher is identified in the auction including identifying a second bid associated with the next finisher and a second expected clickthrough rate associated with second bid. A price is determined that a content sponsor associated with the winner should pay for presentation of the content item, including identifying a third bid and corresponding third expected clickthrough rate dependent on the third bid whose product, being the first product, is substantially equal to a product, being the second product, of the second bid and the second expected clickthrough rate. The content sponsor is charged the price.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or the relevance of the sponsored content to content presented on a page hosting the slot or a request that is received for the sponsored content. The content can be provided to a user device such as a personal computer (PC), a smartphone, a laptop computer, a tablet computer, or some other user device. In some implementations, a price charged to the content sponsor associated with a winning bid can depend on other factors, such as other bids.

### SUMMARY

In general, one innovative aspect of the subject matter described in this specification can be implemented in methods that include a computer-implemented method for pricing content. The method includes identifying a winner associated with an auction for delivery of a content item in response to a request for content, including identifying a first bid associated with the winner and a first expected click-through rate associated with the first bid. The method further includes identifying a next finisher in the auction, including identifying a second bid associated with the next finisher and a second expected click-through rate associated with second bid. The method further includes determining a price that a content sponsor associated with the winner should pay for presentation of the content item responsive to the request including identifying a third bid and a corresponding third expected click-through rate that is dependent on the third bid whose product, being the first product, is substantially equal to a product, being the second product, of the second bid and the second expected click-through rate. The method further includes charging the content sponsor the price for presentation of the content item responsive to the request.

These and other implementations can each optionally include one or more of the following features. Determining the price can include reducing the first bid by an amount, determining an expected click-through rate for the reduced bid, determining the product, being a third product, of the reduced bid and the determined click-through rate associated with the reduced bid, comparing the third product to the second product, and continuing to reduce the first bid until the third product substantially is equal to the second product. Continuing to reduce can include reducing the first bid until the third product is less than the second product and setting the price based on a just previous bid value prior to a last reduction. The request for content can be associated with an ad block that includes plural positions, and the winner can be assigned to a first position and the next finisher is assigned to a second position in the ad block. Determining the price can include reducing the first bid by an amount until a bid is determined that would have resulted in placement of the winner at the second position. The method can further include identifying a third finisher that is associated with a third position in the ad block, reducing the first bid to a first threshold that would have resulted in placement of the winner at the second position, further reducing the first bid to a second threshold that would have resulted in placement of the winner at the third position, and determining the price based on a weighted average of the first and second thresholds.

The third position can be a null position, the ad block may only include two positions, and the second threshold can be a bid that would have resulted in the winner not being presented in either the first or the second positions in the ad block. The method can further include receiving the request for content, identifying a plurality of eligible content items from an inventory of content items that are responsive to the request, wherein the winner and the next finisher are included in the eligible content items, and conducting an auction to identify the winner. The first expected click-through rate can be different than the third expected click-through rate. The first, second and third expected click-through rates can be dependent on their respective bids.

In general, another innovative aspect of the subject matter described in this specification can be implemented in computer program products that include a computer program product tangibly embodied in a computer-readable storage device and comprising instructions. The instructions, when executed by one or more processors, cause the processor to: identify a winner associated with an auction for delivery of a content item in response to a request for content, including identifying a first bid associated with the winner and a first expected click-through rate associated with the first bid; identify a next finisher in the auction, including identifying a second bid associated with the next finisher and a second expected click-through rate associated with second bid; determine a price that a content sponsor associated with the winner should pay for presentation of the content item responsive to the request including: identifying a third bid and a corresponding third expected click-through rate that is dependent on the third bid whose product, being the first product, is substantially equal to a product, being the second product, of the second bid and the second expected click-through rate; and charge the content sponsor the price for presentation of the content item responsive to the request.

These and other implementations can each optionally include one or more of the following features. Determining the price can include reducing the first bid by an amount, determining an expected click-through rate for the reduced bid, determining the product, being a third product, of the reduced bid and the determined click-through rate associated with the reduced bid, comparing the third product to the second product, and continuing to reduce the first bid until the third product substantially is equal to the second product. Continuing to reduce can include reducing the first bid until the third product is less than the second product and setting the price based on a just previous bid value prior to a last reduction. The request for content can be associated with an ad block that includes plural positions, and the winner can be assigned to a first position and the next finisher is assigned to a second position in the ad block. Determining the price can include reducing the first bid by an amount until a bid is determined that would have resulted in placement of the winner at the second position.

In general, another innovative aspect of the subject matter described in this specification can be implemented in systems, including a system that includes a content identification engine that identifies content in response to a received request for content; a bid and pricing engine that determines a price to charge a content sponsor for presentation of a content item responsive to a request, wherein the price is based at least in part on a first bid provided by the content sponsor, the first bid associated with a winner in an auction, and wherein the price is further based on a next finisher in the auction; and a request handler that handles requests for content received by the content management system. The system includes one or more processors and one or more memory elements including instructions. The instructions, when executed, cause the one or more processors to: identify a winner associated with an auction for delivery of a content item in response to a request for content, including identifying a first bid associated with the winner and a first expected click-through rate associated with the first bid; identify a next finisher in the auction, including identifying a second bid associated with the next finisher and a second expected click-through rate associated with second bid; determine a price that a content sponsor associated with the winner should pay for presentation of the content item responsive to the request including: identifying a third bid and a corresponding third expected click-through rate that is dependent on the third bid whose product, being the first product, is substantially equal to a product, being the second product, of the second bid and the second expected click-through rate; and charge the content sponsor the price for presentation of the content item responsive to the request.

These and other implementations can each optionally include one or more of the following features. Determining the price can include reducing the first bid by an amount, determining an expected click-through rate for the reduced bid, determining the product, being a third product, of the reduced bid and the determined click-through rate associated with the reduced bid, comparing the third product to the second product, and continuing to reduce the first bid until the third product substantially is equal to the second product. Continuing to reduce can include reducing the first bid until the third product is less than the second product and setting the price based on a just previous bid value prior to a last reduction. The request for content can be associated with an ad block that includes plural positions, and the winner can be assigned to a first position and the next finisher is assigned to a second position in the ad block. Determining the price can include reducing the first bid by an amount until a bid is determined that would have resulted in placement of the winner at the second position.

Particular implementations may realize none, one or more of the following advantages. Prices charged to a content sponsor related to a winning bid in an auction can be based on one or more other historical bids of the content sponsor and/or bids associated with other content sponsors. Content sponsors can be encouraged to bid truthfully, that is, at an amount that reflects the true value of placing a given impression.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2 shows an example system for determining a price associated with a winning bid in an auction.

FIG. 3 is a flowchart of an example process for determining a price associated with a winning bid in an auction using information from a second-place bid.

FIG. 4 is a block diagram of an example computer system that can be used to implement the methods, systems and processes described in this disclosure.

Like reference numbers and designations in the various drawings indicate like elements.

### DETAILED DESCRIPTION

This document describes systems, methods, computer program products and mechanisms for determining a price associated with a winning bid in an auction. For example, the auction can be run in response to a request for content to fill a content item slot (e.g., an advertisement slot) on a web page or other resource. When a winning bid is determined in the auction, a first expected click-through rate (CTR) associated with the winning bid is determined. A next (e.g., second-place) finisher in the auction is also identified, including identifying a second bid associated with the next finisher and a second expected CTR associated with the second bid. A third bid and a corresponding third expected CTR are identified that are determined from the second bid and the second expected CTR. For example, the product of the third bid and third expected CTR can be substantially equal to a product of the second bid and the second expected CTR. Using the determined third bid, a price can be determined that a content sponsor associated with the winning bid is charged for presentation of the content item. While the examples described in this disclosure focus on bids in an auction for providing content items, the same or similar techniques can be used in other situations in which there exists, associated with each bid, a value other than an expected CTR.

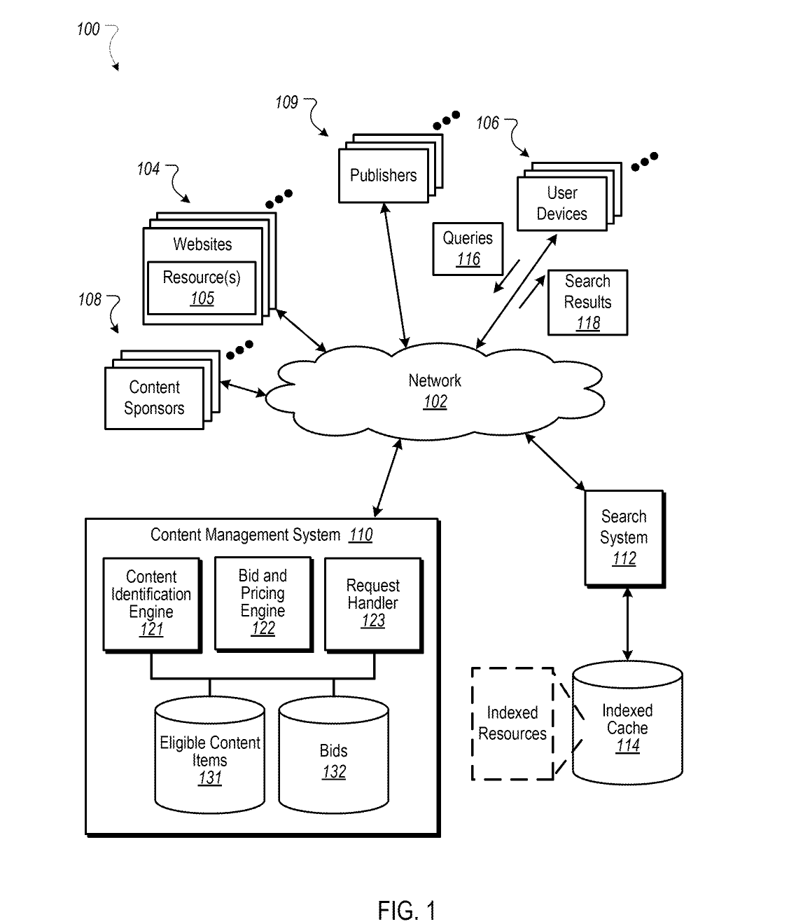

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

The content management system 110 can include plural engines. A content identification engine 121, for example, can identify content (e.g., content items, including advertisements) in response to a received request for content. The identified content can include at least one eligible content item (e.g., from a data store of eligible content items 131, including advertisements) and search results (e.g., search results 118) that are responsive to a query.

A bid and pricing engine 122, for example, can perform (or cause to be performed) an auction using the eligible content items, e.g., identified by the content identification engine 121. The bid and pricing engine 122 can determine an expected CTR that is associated with a winning bid in the auction. The bid and pricing engine 122 can also determine a next (e.g., second-place) finisher in the auction and a second expected CTR associated with a second bid associated with the next finisher. Using a product of the second bid and the second expected CTR, the bid and pricing engine 122 can determine a third bid and a corresponding third expected CTR, the product of the two determined values being substantially equal to a product of the second bid and the second expected CTR. The determining can occur, for example, using an iterative process. Using the determined third bid, the bid and pricing engine 122 can determine a price that a content sponsor associated with the winning bid should pay for presentation of the content item in association with winning the auction.

A request handler 123, for example, can handle requests for content received by the content management system 110, and in response to each request, provide one or more content items to the requestor. For example, the request for content can be a request to fill a content item slot on a web page displayed in a browser on the user device 106. In response to the request for content, the request handler 123 can provide a content item, e.g., a sports shoe advertisement having characteristics that match the characteristics of an advertisement slot on the user device 106. A search system 112 can provide initial search results 118 in response to received search queries 116.

The environment 100 can include plural data stores, which can be stored locally by the content management system 110, stored somewhere else and accessible using the network 102, generated as needed from various data sources, or some combination thereof. A data store of eligible content items 131, for example, can include content items (e.g., advertisements) that can be selected by the content management system 110 in response to a content item request, such as in association with a search query 116 or a received request for content. A data store of bids 132, for example, can include bids that are determined in real time by the bid and pricing engine 122. The bids, for example, can each correspond to an eligible content item that meets selection criteria of a request for content (e.g., related to sports shoes).

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. In some implementations, the search results 118 include the content itself, such as a map, or an answer, such as in response to a query for a store's products, phone number, address or hours of operation. In some implementations, the content management system 110 can generate search results 118 using information (e.g., identified resources) received from the search system 112. An example search result 118 can include a webpage title, a snippet of text or a portion of an image extracted from the webpage, and the URL of the webpage. Search results pages can also include one or more slots in which other content items (e.g., ads) can be presented. In some implementations, slots on search results pages or other webpages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116 that can be presented along with other content on the resource or along with search results responsive to the query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In some implementations, the selection of the eligible content items can further depend on user signals, such as demographic signals and behavioral signals.

The content management system 110 can select from the eligible content items that are to be provided for presentation in slots of a resource or along with search results on a search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations). The offers represent the amounts that the content sponsors are willing to pay for presentation (or selection or other interaction with) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, and/or other factors as described herein.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a website or webpage, registering on a website, experiencing media, or performing a social action regarding a content item (e.g., an ad), such as republishing or sharing the content item. Other actions that constitute a conversion can also be used.

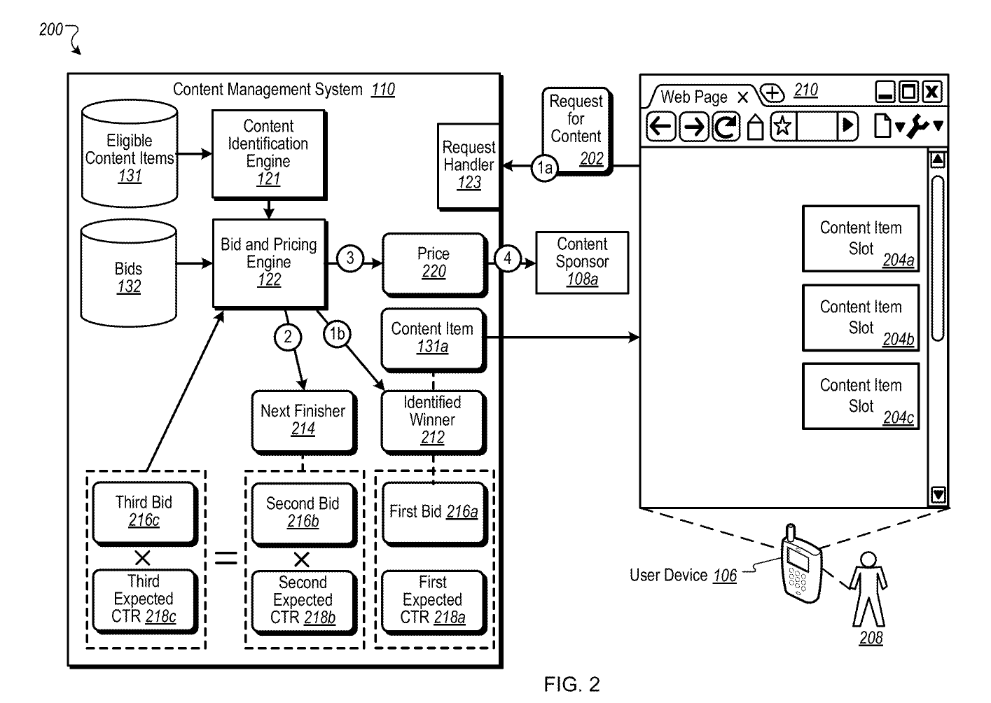

FIG. 2 shows an example system 200 for determining a price 220 associated with a winning bid (e.g., a first bid 216a) in an auction. The price 220 that is determined can be different than the bid amount associated with a highest bid in an auction. For example, the price 220 can be determined based on a second-place finisher in the auction, e.g., by determining a second expected CTR 218b associated with a second bid 216b. A more detailed example follows using an example sequence of stages 1a-4.

At stage 1a, the content management system 110, for example, can receive a request for content 202 from the user device 106. For example, the request for content 202 can be a request for a content item (e.g., an advertisement) to fill a content item slot 204a (e.g., an advertisement slot) on a web page 210 being accessed by a user 208. Other sources for content request are possible. In some implementations, the request for content 202 can be received by the request handler 123. The request for content 202 can include terms, phrases or other selection criteria, e.g., based on the user's location, interests, device type, and/or other criteria.

At stage 1b, for example, the content identification engine 121 can identify eligible content items that match the request for content. From the identified eligible content items, an auction can be run. The bid and pricing engine 122 can identify a winner 212 associated with the auction, the winner 212 being a content item chosen for delivery in response to the request for content 202. Identifying the winner 212 includes identifying a first bid associated with the winner 212 and a first expected CTR 218a associated with the first bid. For example, the winner 212 in the auction can be an advertisement for Brand A walking shoes having the highest relative bid among other bids associated with other eligible content items related to sports shoes. Bids can be scored/ranked. In some implementations, bids are adjusted using a quality score/factor. In some implementations, the quality score can be a measure of one or more factors including an expected click-through rate for the related content item. Expected click-through rates can be determined using numerous different factors including factors related to the quality of the underlying content, historical click-through data related to the content or content source among other factors. Expected click-through rates can be used to not only to assist in determining the relative bid, but also in pricing as will be discussed in further detail below. The bid and pricing engine 122 can determine an estimated CTR (e.g., X %) that is associated with the highest relative bid.

At stage 2, for example, the bid and pricing engine 122 can identify a next finisher 214 in the auction. Identifying the next finisher 214 includes identifying the second bid 216b associated with the next finisher 214 and an expected click-through rate (i.e., the second expected CTR 218b) associated with second bid 216b. As an example, the second bid 216b (e.g., eight cents) in the auction can be associated with an advertisement for brand B running shoes. The bid and pricing engine 122 can determine the second expected CTR 218b (e.g., Y %) that is associated with the second bid 216.

At stage 3, for example, the bid and pricing engine 122 can determine a price 220 that a content sponsor associated with the winner should pay for presentation of the content item responsive to the request. Determining the price 220 can include identifying a third bid 216c and a corresponding third expected CTR 218c that is dependent on the third bid 216c whose product, being the first product, is substantially equal to a product, being the second product, of the second bid 216b and the second expected CTR 218b.

At stage 4, for example, the bid and pricing engine 122 can charge a content sponsor 108a associated with the winning bid the determined price 220 for presentation of a content item responsive to the request. For example, the price (e.g., a price that is less than ten cents) charged to the content sponsor may be different than the price that corresponds to the bid (e.g., ten cents) of the content sponsor.

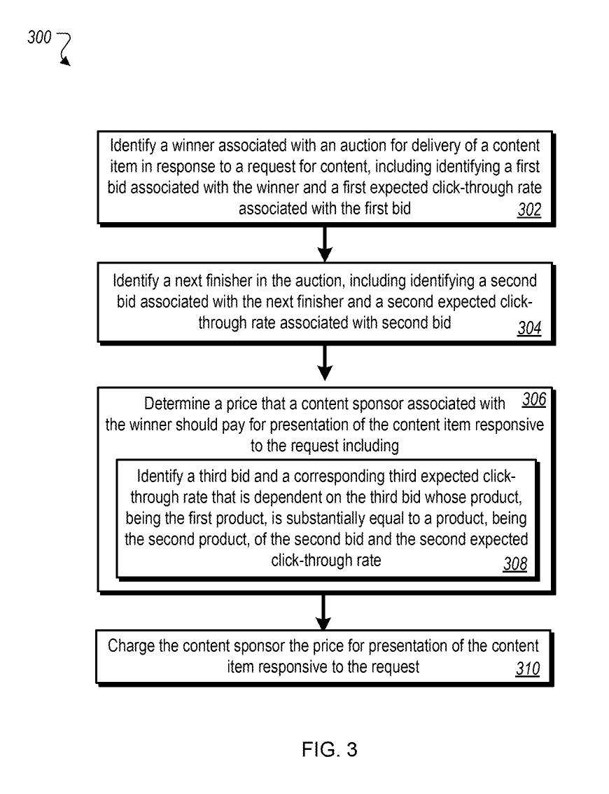

FIG. 3 is a flowchart of an example process 300 for determining a price associated with a winning bid in an auction using information from a second-place bid. In some implementations, the content management system 110 can perform stages of the process 300 using instructions that are executed by one or more processors. FIGS. 1-2 are used to provide example structures for performing the stages of the process 300.

A winner associated with an auction is identified for delivery of a content item in response to a request for content (302). Identifying the winner includes identifying a first bid associated with the winner and a first expected CTR associated with the first bid. For example, in an auction run for eligible content items 131 matching the request for content 202 (e.g., related to sports shoes), the bid and pricing engine 122 can identify a winner 212 associated with the auction. As an example, the winner 212 in the auction can be an advertisement for Brand A walking shoes having the highest relative bid (e.g., in this case a bid of ten cents) among other relative bids associated with other eligible content items 131 related to sports hoes. Identifying the winner 212 includes identifying the first bid 216a associated with the winner 212 and a first expected CTR 218a associated with the first bid 216a. For example, the bid and pricing engine 122 can determine an estimated CTR (e.g., X %) that is associated with the highest relative bid (e.g., first bid 216a).

A next finisher is identified in the auction (304). Identifying the next finisher includes identifying a second bid associated with the next finisher and a second expected CTR associated with the second bid. For example, the bid and pricing engine 122 can identify the second bid 216b (e.g., eight cents) in the auction that is associated with an advertisement for Brand B running shoes. The bid and pricing engine 122 can determine the second expected CTR 218b (e.g., Y %) that is associated with the second bid 216b.

A price is determined that a content sponsor associated with the winner should pay for presentation of the content item responsive to the request (306). Determining the price includes identifying a third bid and a corresponding third expected CTR that is dependent on the third bid whose product, being the first product, is substantially equal to a product, being the second product, of the second bid and the second expected CTR (308). For example, the price 220 (e.g., price-per-click) that is determined for the winning advertisement for Brand A walking shoes can depend on the second bid 216b associated with the advertisement for Brand B running shoes. In this example, the determined price-per-click (e.g., N cents) is calculated by dividing the product of the second bid 216b and the second expected CTR 218b by an expected CTR for the Brand A advertisement at the determined price-per-click. In some implementations, this can be an iterative calculation, e.g., iterating until the third product substantially equals the second product. In some implementations, the determined price-per-click (e.g., N cents) can be less than the first bid 216a (e.g., ten cents) and greater than or less than the second bid 216b (e.g., eight cents).

In some implementations, the first expected CTR can be different than the third expected CTR. For example, as a result of the iterative calculations described above, the third expected CTR 218c can be different from the first expected CTR 218a, e.g., more consistent with bid that reflects the true value of placing a given impression.

In some implementations, the first, second and third expected CTRs can be dependent on their respective bids. As an example, pricing engines such as the bid and pricing engine 122 can typically determine expected CTRs 218a-218c (e.g., X %, Y % and Z %, respectively) that are proportional to the respective bids (e.g., ten cents, eight cents, and N cents, respectively).

In some implementations, the request for content can be associated with an ad block that includes plural positions, and wherein the winner is assigned to a first position and the next finisher is assigned to a second position in the ad block. For example, the request for content 202 provided by the user device 106 can be a request to fill two slots, e.g., content item slots 204a and 204b. As a result of the auction, the content item associated with the identified winner 212 can be presented in one slot, e.g., the content item slot 204a, which may be more prominent than the content item slot 204b. Also, the content item associated with the next finisher 214 can be presented in the other slot, e.g., the content item slot 204b.

In some implementations, determining the price can include reducing the first bid by an amount until a bid is determined that would have resulted in placement of the winner at the second position. As an example, the bid and pricing engine 122 can iteratively reduce the first bid until the bid is such that the identified winner 212 would be chosen for the content item slot 204b. At this time, the bid determined in the previous iteration can be used for the price 220.

In some implementations, determining the price can include the use of an iterative process, e.g., performed by the bid and pricing engine 122. For example, a current value of the first bid 216a can be reduced by an amount from which an expected CTR can be determined. In some implementations, the iterations can begin, for example, by setting the third bid 216c to the value of the first bid 216a, and iteratively adjusting the third bid 216c in the iterative process. A product, being a third product, can be determined from the reduced bid (e.g., current value of the third bid 216c) and the determined CTR (e.g., the third expected CTR 218c) associated with the reduced bid. The product can be compared to the second product, e.g., the product of the second bid 216b and the second expected CTR 218b. Iterations can continue to reduce the bid until the third product substantially is equal to the second product.

In some implementations, continuing to reduce the first bid can include reducing the first bid until the third product is less than the second product and setting the price based on a just previous bid value prior to a last reduction. For example, the iterations performed by the bid and pricing engine 122 can continue until the product of the third expected CTR 218c and the third bid 216c is less than the product of the second bid 216b and the second expected CTR 218b. At that time, the previous value of the third bid 216c, e.g., before that iteration, can be used as the price 220.

The content sponsor is charged the price for presentation of the content item responsive to the request (310). For example, the content management system 110 can charge the content sponsor 108a the determined price 220.

In some implementations, the process 300 can further include identifying a third finisher that is associated with a third position in the ad block, reducing the first bid to a first threshold that would have resulted in placement of the winner at the second position, further reducing the first bid to a second threshold that would have resulted in placement of the winner at the third position, and determining the price based on a weighted average of the first and second thresholds. For example, content item slots 204a-204c can be three slots in an ad block on the web page 210. In this example, the bid and pricing engine 122 can perform two separate iterations. The first iteration can reduce the bid associated with the identified winner to arrive at a second place threshold bid (e.g., J cents) that would place the content item in the second finishing position. The second iteration can reduce the bid associated with the identified winner to arrive at a third place threshold bid (e.g., K cents) that would place the content item in the third finishing position. To compute the price 220, in some implementations, the bid and pricing engine 122 can use a weighted average of the second place threshold bid (e.g., J cents) and the third place threshold bid (e.g., K cents). For example, the weighted average can be based on using 80% of the second place threshold bid (e.g., J cents) and 20% of the third place threshold bid (e.g., K cents), or some other weighted average.

In some implementations, the third position can be a null position, the ad block can include only two positions, and the second threshold can be a bid that would have resulted in the winner not being presented in either the first or the second positions in the ad block. For example, the content item slot 204c may not exist, but the bid and pricing engine 122 can still perform two separate iterations as in the previous example when three slots exist. In this example, the iterations can continue until the bid price for the identified winner 212 is low enough to lose to the second-place and third-place bids. The price 220 can then be based on the bid at that iteration (or the one before).

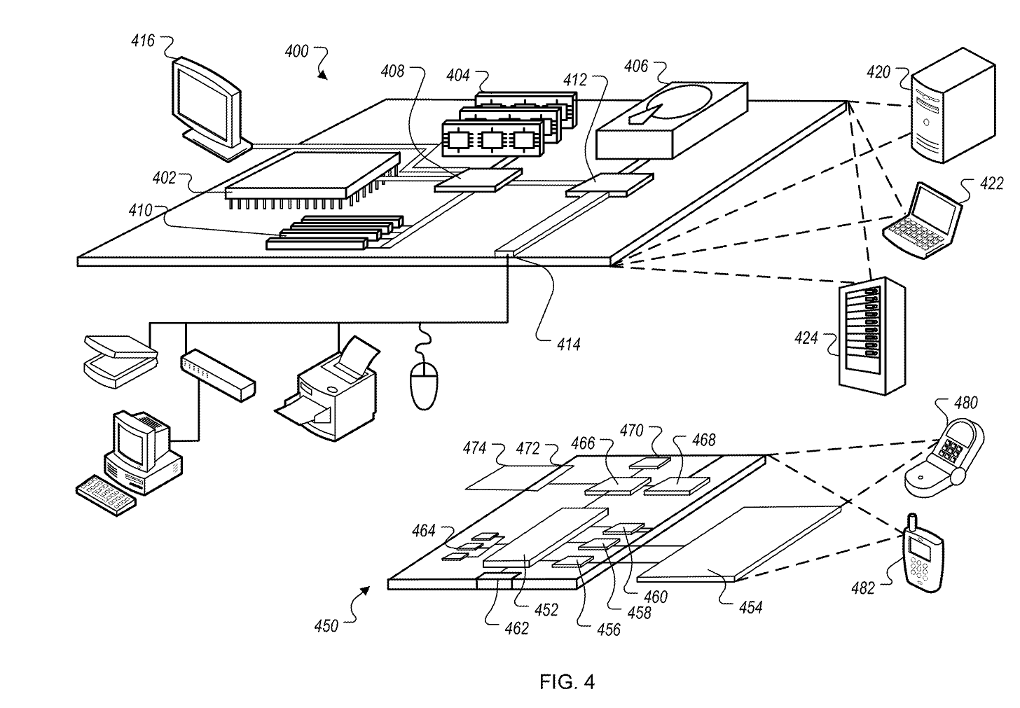

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processors embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying a winner associated with an auction for delivery of a content item in response to a request for content, including identifying a first bid associated with the winner and a first expected click-through rate associated with the first bid;
identifying a next finisher in the auction, including identifying a second bid associated with the next finisher and a second expected click-through rate associated with second bid;
determining a price that a content sponsor associated with the winner should pay for presentation of the content item responsive to the request including:
identifying a third bid and a corresponding third expected click-through rate that is dependent on the third bid whose product, being the first product, is substantially equal to a product, being the second product, of the second bid and the second expected click-through rate; and
charging the content sponsor the price for presentation of the content item responsive to the request.

2. The method of claim 1 wherein determining the price includes reducing the first bid by an amount, determining an expected click-through rate for the reduced bid, determining the product, being a third product, of the reduced bid and the determined click-through rate associated with the reduced bid, comparing the third product to the second product, and continuing to reduce the first bid until the third product substantially is equal to the second product.

3. The method of claim 2 wherein continuing to reduce includes reducing the first bid until the third product is less than the second product and setting the price based on a just previous bid value prior to a last reduction.

4. The method of claim 1 wherein the request for content is associated with an ad block that includes plural positions, and wherein the winner is assigned to a first position and the next finisher is assigned to a second position in the ad block.

5. The method of claim 4 wherein determining the price includes reducing the first bid by an amount until a bid is determined that would have resulted in placement of the winner at the second position.

6. The method of claim 5 further comprising:
identifying a third finisher that is associated with a third position in the ad block;
reducing the first bid to a first threshold that would have resulted in placement of the winner at the second position;
further reducing the first bid to a second threshold that would have resulted in placement of the winner at the third position; and
determining the price based on a weighted average of the first and second thresholds.

7. The method of claim 6 wherein the third position is a null position, the ad block only includes two positions, and the second threshold is a bid that would have resulted in the winner not being presented in either the first or the second positions in the ad block.

8. The method of claim 1 further comprising:
receiving the request for content;
identifying a plurality of eligible content items from an inventory of content items that are responsive to the request, wherein the winner and the next finisher are included in the eligible content items; and
conducting an auction to identify the winner.

9. The method of claim 1 wherein the first expected click-through rate is different than the third expected click-through rate.

10. The method of claim 1 wherein the first, second and third expected click-through rates are dependent on their respective bids.

11. A computer program product embodied in a non-transitive computer-readable medium including instructions, that when executed, cause one or more processors to:
identify a winner associated with an auction for delivery of a content item in response to a request for content, including identifying a first bid associated with the winner and a first expected click-through rate associated with the first bid;
identify a next finisher in the auction, including identifying a second bid associated with the next finisher and a second expected click-through rate associated with second bid;
determine a price that a content sponsor associated with the winner should pay for presentation of the content item responsive to the request including:
identifying a third bid and a corresponding third expected click-through rate that is dependent on the third bid whose product, being the first product, is substantially equal to a product, being the second product, of the second bid and the second expected click-through rate; and
charge the content sponsor the price for presentation of the content item responsive to the request.

12. The computer program product of claim 11 wherein determining the price includes reducing the first bid by an amount, determining an expected click-through rate for the reduced bid, determining the product, being a third product, of the reduced bid and the determined click-through rate associated with the reduced bid, comparing the third product to the second product, and continuing to reduce the first bid until the third product substantially is equal to the second product.

13. The computer program product of claim 12 wherein continuing to reduce includes reducing the first bid until the third product is less than the second product and setting the price based on a just previous bid value prior to a last reduction.

14. The computer program product of claim 11 wherein the request for content is associated with an ad block that includes plural positions, and wherein the winner is assigned to a first position and the next finisher is assigned to a second position in the ad block.

15. The computer program product of claim 14 wherein determining the price includes reducing the first bid by an amount until a bid is determined that would have resulted in placement of the winner at the second position.

16. A content management system comprising:
a content identification engine that identifies content in response to a received request for content;
a bid and pricing engine that determines a price to charge a content sponsor for presentation of a content item responsive to a request, wherein the price is based at least in part on a first bid provided by the content sponsor, the first bid associated with a winner in an auction, and wherein the price is further based on a next finisher in the auction;
a request handler that handles requests for content received by the content management system;
one or more processors; and
one or more memory elements including instructions that, when executed, cause the one or more processors to:
identify a winner associated with an auction for delivery of a content item in response to a request for content, including identifying a first bid associated with the winner and a first expected click-through rate associated with the first bid;
identify a next finisher in the auction, including identifying a second bid associated with the next finisher and a second expected click-through rate associated with second bid;
determine a price that a content sponsor associated with the winner should pay for presentation of the content item responsive to the request including:
identifying a third bid and a corresponding third expected click-through rate that is dependent on the third bid whose product, being the first product, is substantially equal to a product, being the second product, of the second bid and the second expected click-through rate; and
charge the content sponsor the price for presentation of the content item responsive to the request.

17. The content management system of claim 16 wherein determining the price includes reducing the first bid by an amount, determining an expected click-through rate for the reduced bid, determining the product, being a third product, of the reduced bid and the determined click-through rate associated with the reduced bid, comparing the third product to the second product, and continuing to reduce the first bid until the third product substantially is equal to the second product.

18. The content management system of claim 17 wherein continuing to reduce includes reducing the first bid until the third product is less than the second product and setting the price based on a just previous bid value prior to a last reduction.

19. The content management system of claim 16 wherein the request for content is associated with an ad block that includes plural positions, and wherein the winner is assigned to a first position and the next finisher is assigned to a second position in the ad block.

20. The content management system of claim 19 wherein determining the price includes reducing the first bid by an amount until a bid is determined that would have resulted in placement of the winner at the second position.
